(19) United States
(12) Patent Application Publication
(10) Pub. No.: US 2012/0303552 A1
(43) Pub. Date: Nov. 29, 2012

(54) TECHNIQUES TO TRACK USERS AND USER METRICS FOR A WEBSITE

(75) Inventors: Mitchell Zayas, Hialeah, FL (US); Steve Snyder, Redwood City, CA (US)

(73) Assignee: CBS INTERACTIVE INC., San Francisco, CA (US)

(21) Appl. No.: 13/118,002

(22) Filed: May 27, 2011

(51) Int. Cl. G06F 15/16; G06Q 30/00

(52) U.S. Cl. 705/400; 709/224

(57) ABSTRACT

Techniques to track users and user metrics for a website are described. For example, one embodiments may include identifying one or more users of a website, tracking one or more activities for each user, generating a database arranged to store the one or more activities for each user, and calculating one or more user metrics based on the stored activities, wherein the user metrics comprise one or more of a user value, content value, product value, service value or campaign value. Other embodiments are described and claimed.

### BACKGROUND

Modern websites include a diverse set of media and content. Users of these websites often access and interact with this media and content in a variety of ways. Tracking and maintaining up to date information regarding users and their value, behavior, activity and value derived from different components of a website is one important aspect of maintaining a website. When a user visits a website, it is advantageous to track and record their activities to analytically determine what portions of a website are being accessed and what media and content are resulting in value to the owner of the site. As a result, it is desirable to enhance user metric tracking for a website and users of the website. For example, it may be advantageous to create a tool that is operative to generate a database and calculate user metrics for different users and different website elements from the information in the database. Consequently, there exists a substantial need for techniques to improve user metric tracking for websites. It is with respect to these and other considerations that the present improvements have been needed.

### BRIEF DESCRIPTION OF THE DRAWINGS

FIG. 1 illustrates an embodiment of a first system.

FIG. 2 illustrates an embodiment of second system.

FIG. 3A illustrates an embodiment of a first report.

FIG. 3B illustrates an embodiment of a second report.

FIG. 4 illustrates an embodiment of a third report.

FIG. 5 illustrates an embodiment of a fourth report.

FIG. 6 illustrates an embodiment of a fifth report.

FIG. 7 illustrates an embodiment of a sixth report.

FIG. 8 illustrates an embodiment of a seventh report.

FIG. 9 illustrates an embodiment of a eighth report.

FIG. 10 illustrates an embodiment of a ninth report.

FIG. 11. Illustrates an embodiment of a logic flow.

FIG. 12 illustrates an embodiment of a computing architecture.

FIG. 13 illustrates an embodiment of a communications architecture.

### DETAILED DESCRIPTION

Various embodiments are directed to techniques to track users and user metrics for a website. In some embodiments, for example, a computer-implemented method to track users and report user metrics for a website may comprise identifying one or more users of a website, tracking one or more activities for each user, generating a database arranged to store the one or more activities for each user, and calculating one or more user metrics based on the stored activities, wherein the user metrics comprise one or more characteristics of a user or group of users or a user value, content value, product value, service value or campaign value. Other embodiments are described and claimed.

Tracking of data and statistics related to a website or other business is not new. Current techniques for website statistics tracking rely on a counting method to accumulate information about the website. For example, typical information collected may include a number of page views, a number of users, a number of links, a number of hits or an amount of time spent on a site by a user. From this information, owners and administrators of websites perform analysis in an effort to make decisions related to the website and their business.

Current websites include, among other things, a variety of pages, sub-sites, media, content, advertisements and products. These website elements or components are often stored or supported by different servers. Because the information is spread out throughout a website ecosystem, collecting and accumulating data from these different sources in an efficient manner is a problem for current website owners and administrators. The relevant information may be stored in a variety of systems or servers and it may be impractical to conduct cross-system analyses because the data is stored in different locations at different levels of granularity.

In many current systems it is also difficult to extract any pan-session insights (e.g. spanning more than one session) due to current data expiration policies that for some systems may be as little as thirty-five days or less. For a seasonal business, such as a business that focuses on sports and sports seasons, year over year comparisons and understanding of user consumption of content, products, services and offers over many years is a must. Therefore, some embodiments described herein provide techniques for summarizing and storing, in a common location, key information from all users that visit a website over an extended period of time. Additionally, some embodiments may be directed to deriving user metrics from the information that is collected. For example, in various embodiments, user metrics may be calculated to improve the quality and usefulness of the information that is tracked and recorded.

From the recorded information, in some embodiments, a series of periodic reports that depart from traditional methods of counting may be generated that may result in a greater understanding of business performance and may focus on value-based analytics that depict “value” from different perspectives. For example, the value of content, products, services, users, groups of users, offers and campaigns may be identified and tracked. These and other features are described in the following techniques, methods, articles and apparatus. As a result, the described embodiments can improve the dynamic tracking of users and user metrics for a website.

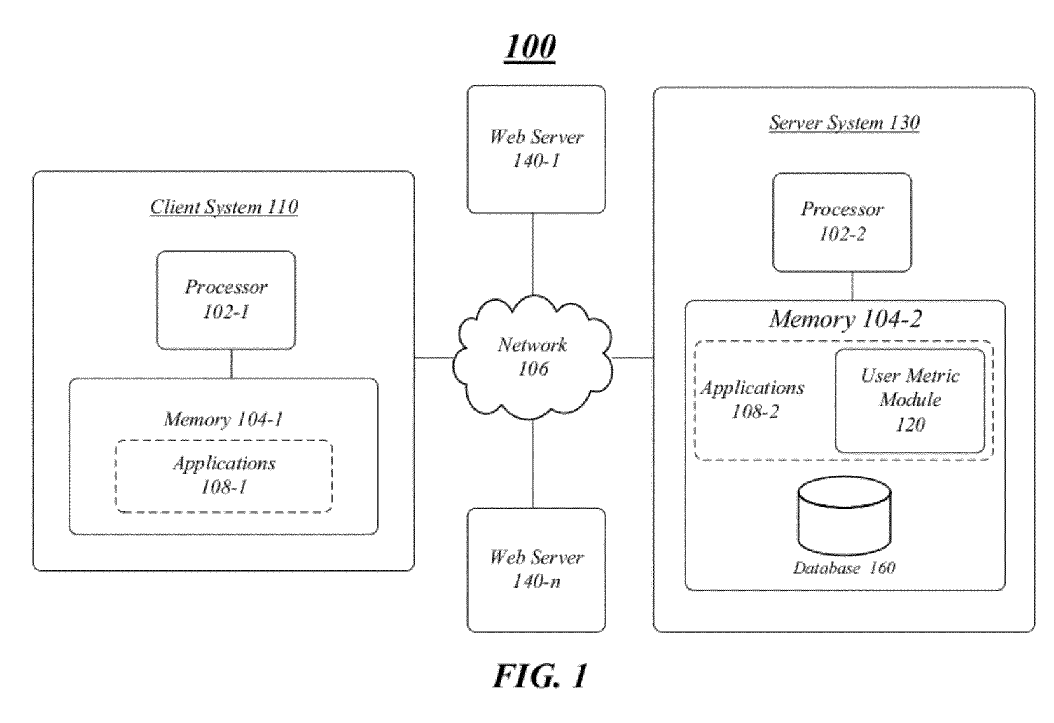

FIG. 1 illustrates a block diagram for a system 100 to track and report user metrics for a website. In one embodiment, for example, the system 100 may comprise a computer-implemented system 100 having multiple components 110, 130 and 140-1-n. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 110, 130 and 140-1-n may be communicatively coupled via various types of communications media. The components 110, 130 and 140-1-n may coordinate operations between each other. The coordination may involve the uni-directional or bi-directional exchange of information. For instance, the components 110, 130 and 140-1-n may communicate information in the form of signals communicated over network 106. The information can be implemented as signals allocated to various signal lines or signals transmitted using any suitable signaling protocol. Other embodiments are described and claimed.

System 100 may comprise a distributed system in some embodiments. The distributed system 100 may distribute portions of the structure and/or operations for the system across multiple computing entities. Examples of distributed system 100 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, for example, the distributed system 100 may be implemented as a client-server system. A client 110 may be implemented as or comprise a user device, such as a personal computer, that may include one or more applications 108-1. A server system 130 may comprise a web server or other suitable device and may implement user metric module 120 and database 160. Web servers 140-1-n may comprise servers arranged to provide, host or support one or more websites for one or more owners or administrators. The client 110 and the servers systems 130 and 140-1-n may communicate with each over a network 106. In one embodiment, for example, the network 106 may comprise a wireless local area network (WLAN) or any other suitable computer network.

In various embodiments, the servers 130 and 140-1-n may comprise or employ one or more server computing devices and/or server programs that operate to perform various methodologies in accordance with the described embodiments. For example, when installed and/or deployed, a server program may support one or more server roles of the server computing device for providing certain services and features. Exemplary servers 130 and 140-1-n may include, for example, stand-alone and enterprise-class server computers operating a server OS such as a MICROSOFT® OS, a UNIX® OS, a LINUX® OS, or other suitable server-based OS. Exemplary server programs may include, for example, communications server programs such as Microsoft® Office Communications Server (OCS) for managing incoming and outgoing messages, messaging server programs such as Microsoft® Exchange Server for providing unified messaging (UM) for e-mail, voicemail, VoIP, instant messaging (IM), group IM, enhanced presence, and audio-video conferencing, and/or other types of programs, applications, or services in accordance with the described embodiments.

In various embodiments, client system 110 and server system 130 may include, without limitation processors 102-1 and 102-2, memory 104-1 and 104-2 and applications 108-1 and 108-2. While not shown in FIG. 1, web servers 140-1-n may include the same or similar components to server system 130. In some embodiments, server system 130 may additionally include user metric module 120. User metric module 120 may comprise one of applications 108-2 in some embodiments. In various embodiments, user metric module 120 may comprise hardware, software or any combination of hardware and software and still fall within the described embodiments. While user metric module 120 is shown as part of server system 130 in FIG. 1, it should be understood that user metric module 120 could be included anywhere in system 100 and still fall within the described embodiments. For example, user metric module 120 could be implemented on any of web servers 140-1-n in some embodiments. Other embodiments are described and claimed.

Processors 108-1 and 108-2 may comprise or include any type of processing unit, such as, for example, CPU, multi-core processor, multi-processing unit, a reduced instruction set computer (RISC), a processor that has a pipeline, a complex instruction set computer (CISC), digital signal processor (DSP), and so forth. In some embodiments, processors 102-1 and 102-2 may comprise or include logical and/or virtual processor cores. Each logical processor core may include one or more virtual processor cores in some embodiments. For example, each processor 102-1 and 102-2 may comprise a multi-core processor having two virtual cores resulting in a total of eight available cores for multi-core processors 102-1 and 102-2. The embodiments are not limited in this respect and other embodiments are described and claimed.

In various embodiments, memory 104-1 and 104-2 may comprise any suitable type of memory unit, memory device, memory article, memory medium, storage device, storage article, storage medium and/or storage unit, for example, memory, removable or non-removable media, volatile or non-volatile memory or media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

Applications 108-1 and 108-2 may comprise any application, logic, module or set of computer instructions suitable for execution by client system 110 or server system 130 in some embodiments. For example, applications 108-1 and 108-2 may include, without limitation, an operating system (OS), e-mail application, web browsing application, word processing application, media application, and so forth. While a limited number and type of applications are described for purposes of clarity, it should be understood that any suitable application could be used and still fall within the described embodiments.

In various embodiments, user metric module 120 may comprise one of applications 108-2. While user metric module 120 is shown as an application 108-2 contained in memory 104-2 for purposes of illustration, it should be understood that user metric module 120 could be located anywhere in system 100 and still fall within the described embodiments. For example, user metric module 120 need not be contained within memory 104-2. User metric module 120 may provide or comprise a user metric module, application or tool in some embodiments. For example, user metric module 120, when executed by processor 102-2, may be operative to track and report user metric information related to a user of client system 110 that is interacting with one or more websites supported by web servers 140-1-n. Other embodiments are described and claimed.

In various embodiments, user metric module 120 may be programmed in accordance with various programming languages, application platforms and application frameworks, including JAVA made by Oracle Corporation, COLDFUSION made by Adobe Systems, .NET made by Microsoft® Corporation, WebORB for .NET, Hypertext Preprocessor (PHP), Ruby, Python, Perl, Lisp, Dylan, Pike, Cluster (CLU), Smalltalk, Eiffel, Ruby on Rails (RoR), C, C++, C#, and so forth. The logic 120 may also comprise part of a RIA, such as a front-end of a SOA for deployment on a web browser of a client computing device using various client side technologies, such as an Adobe Flash platform programmed in an object-oriented programming language such as ACTIONSCRIPT™ and ADOBE® FLEX, made by Adobe Systems Incorporated. It may be appreciated that these programming languages are provided by way of example and not limitation. User metric module 120 may be implemented using any suitable programming language.

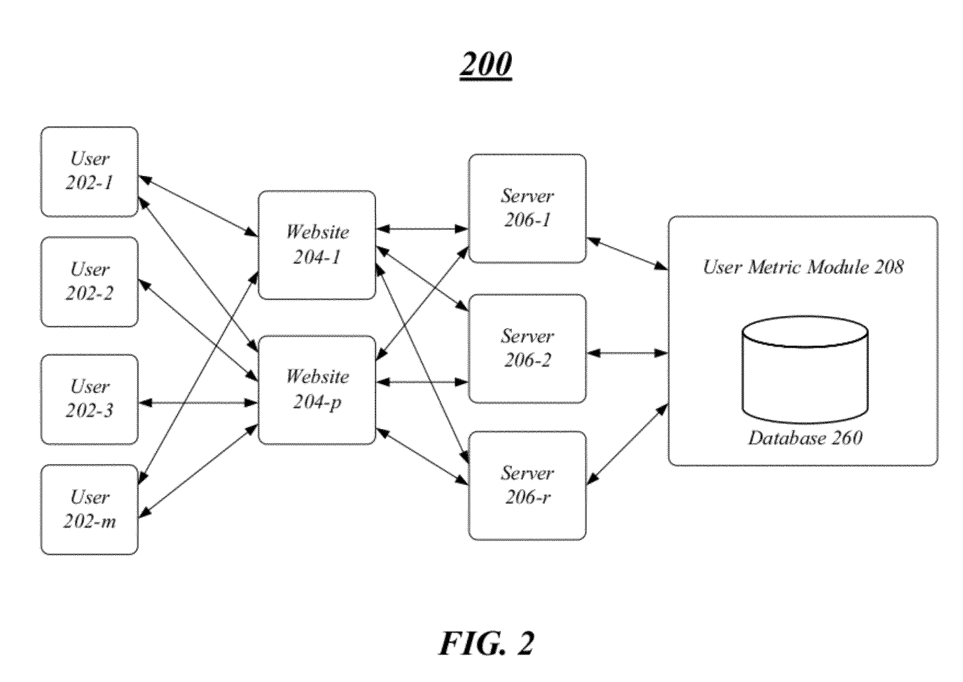

FIG. 2 illustrates a block diagram for a system 200 to track and report user metrics for a website. In one embodiment, for example, the system 200 may comprise a computer-implemented system 200 having multiple components 202-1-m, 204-1-p, 206-1-r, 208 and 260. In some embodiments, the system 200 may be the same or similar to the system 100 of FIG. 1 and as such, may contain like components, elements and modules. A limited number and type of components are shown in system 200 for purposes of illustration. The embodiments are not limited in this context.

In some embodiments, user metric module 208, which may be the same or similar to user metric module 120 of FIG. 1, may be operative to identify one or more users 202-1-m of a website 204-1-p. For example, a user 202-1 of may access websites 204-1 and 204-p hosted or supported by servers 206-1-r. When the user accesses the sites, user metric module 208 may be operative to gather identifying information from the user, such as cookies from the users browser or a user identification or registration name or number.

In various embodiments, after identifying the one or more users, user metric module 208 may be operative to track one or more activities for each user. For example, a user 202-2 may access a website 204-p containing news stories, user reviews, fantasy sports games, advertisements or other suitable content supported by servers 206-1-r. The user may elect to read certain content, view certain pages, click on certain links and otherwise interact with the website 204-p in accordance with their own personal preferences. For example, the user 202-2 may wish to read a story about a professional golfer, check up on their fantasy baseball team and click on a link to an advertisement for a pay per view sporting event. In various embodiments, user metric module 208 may be operative to record or track each of these user interactions. While a limited number and type of user interactions are described for purposes of illustration, it should be understood that any suitable user interaction could be used and still fall within the described embodiments.

User metric module 208 may be operative to generate a database arranged to store the one or more activities for each user in some embodiments. For example, user metric module 208 may generate or populate database 260. Database 260 may comprise any system, device or logic operative to organize, store, and retrieve data or any organized collection of data for one or more uses, typically in digital form. In various embodiments, database 260 may be operative to store relational tables, indexes, registers or other reports in memory or on hard disk or other memory device in one of many forms, including but not limited to ordered/unordered flat files, ISAM, heaps, hash buckets, logically-blocked files, Fractal Tree indexes, or B+ trees. One skilled in the art will understand that any suitable database type or structure could be used and still fall within the described embodiments.

In various embodiments, user metric module 208 may be operative to calculate one or more user metrics based on the stored activities. For example, user metric module may be operative to calculate user metrics comprising one or more of user attributes, user characteristics, groups of user, a user value, content value, product value, service value or campaign value. In some embodiments, a user metric of value may be calculated based on a sum of revenues generated by a user during one or more visits to the website. For example, a user 202-3 may visit website 204-p and while on the website, may subscribe to a newsletter or may click on paid advertisements on the website 204-p. Each of these actions may generate revenue for the owner of the website 204-p and this revenue may be attributed to the user in the form of user value that is tracked in database 260.

A content value may be calculated based on a sum revenues generated by each user for content on the website in some embodiments. For example, user metric module 208 may be operative to track and record in database 260 revenue generated by different types of content on one or more websites. Similarly, a product value may be calculated based on a sum of revenues generated by each user for one or more products on the website or a service value may be calculated based on a sum of revenues generated by each user for one or more services on the website. In various embodiments, a campaign value may be calculated based on a sum of revenues generated by users taking a desired action associated with one or more campaigns. While a limited number and type of user metrics are described for purposes of illustration, the embodiments are not limited in this context.

In various embodiments, the value of content, products and services as measured by the sum of all net subscription revenue and net advertising revenue generated may be calculated. In some embodiments, “content” may include, but is not limited to pages, site-sections, videos, and polls. “Products” may include, but is not limited to, free and paid fantasy games, for example. In various embodiments, “services” may include, but are not limited to blogs, message boards and alerts. Collectively, these values may be referenced to as a “product portfolio.”

The value of each user that visits a website may be measured by the sum of all net subscription revenue and net advertising revenue he/she generates. Users with similar attributes may be grouped into classes and the value of a particular class may be measured by the sum of all net subscription revenue and net advertising revenue of users in the class. This may be referred to as a “user portfolio.” In various embodiments, the value of offers and campaigns at getting users to take desired actions as measured by the sum of all net subscription revenue and net advertising revenue generated by users since taking the desired action (e.g. lifetime value) may comprise “campaign attribution.” Other embodiments are described and claimed.

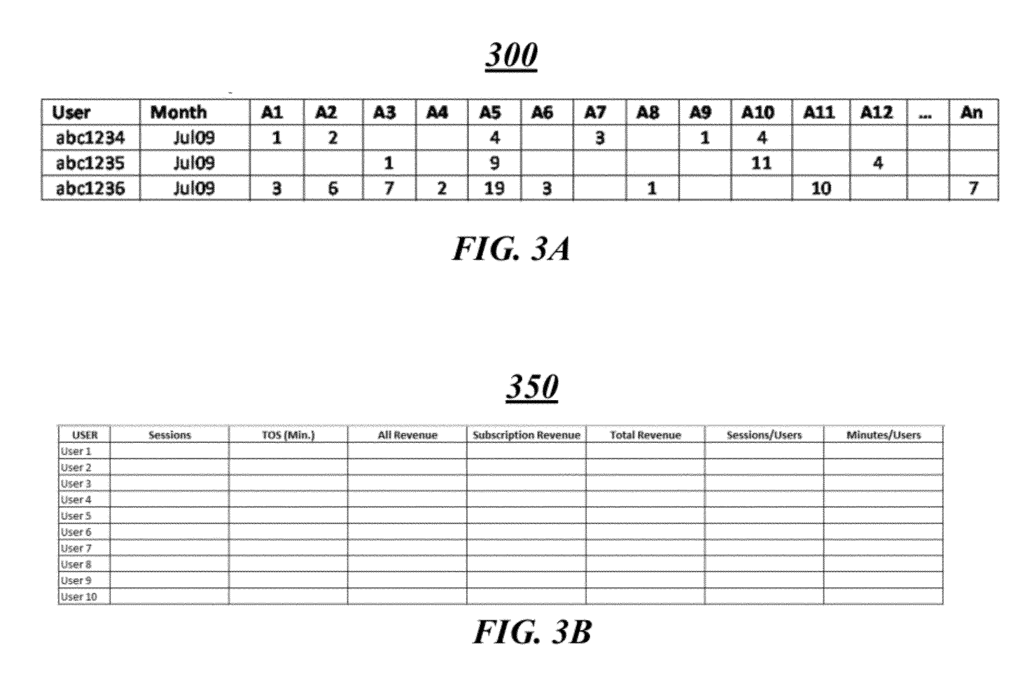

In various embodiments, in order to provide cross-system views of data, a series of common keys between source systems or servers 206-1-r may be necessary. Furthermore, in some embodiments, in order to provide pan-session views of data (e.g. views spanning more than one session), the data must be stored at a user-level and kept for long periods of time. For example, database 260 may be operative to store data at the user/month level or one row per user per month, as illustrated in table 300 of FIG. 3A. In some embodiments, the data in database 260 will not expire or be overwritten for a minimum of five years. This will allow for lifetime value calculations spanning multiple sport seasons, user return interval analyses and long-term pan-session analyses.

Database 260 may comprise a separate data store that extracts or stores key data from the source systems and stores it for long periods of time in some embodiments. For example, any end-user reports, analyses and insights that are desired or requested by the owner or administrator of a website 204-1-p may originate from this database 260, thereby minimizing the need to change existing source systems and databases that may be associated with or dedicated to servers 206-1-r, and eliminate the need to burden these system with queries when requests for information would otherwise be made.

In some embodiments, one or more visual reports may be generated based on the stored activities or the calculated user metrics. For example, table 350 of FIG. 3B illustrates one example of a user value report that may be generated based on data obtained by user metric module 208 and stored in database 260. While a limited number of users and types of data are shown in table 300 for purposes of illustration, it should be understood that any suitable data could be shown in the visual report 300 and still fall within the described embodiments.

In various embodiments, user metric module 208 may be operative to generate product portfolios that depict value across product lines of a website or family of websites. In the case of CBSSports.com, for example, the “product line” may consist of the various site sections and page types users consume each month. In some embodiments, as the users consume sports content on sections and page types, users are exposed to ads which generate ad revenue for the owner of the website. Users can also purchase fantasy products on CBSSports.com resulting in subscription revenue. Together, net ad revenue and net subscription revenue describe the “value” of site sections and page types in some embodiments.

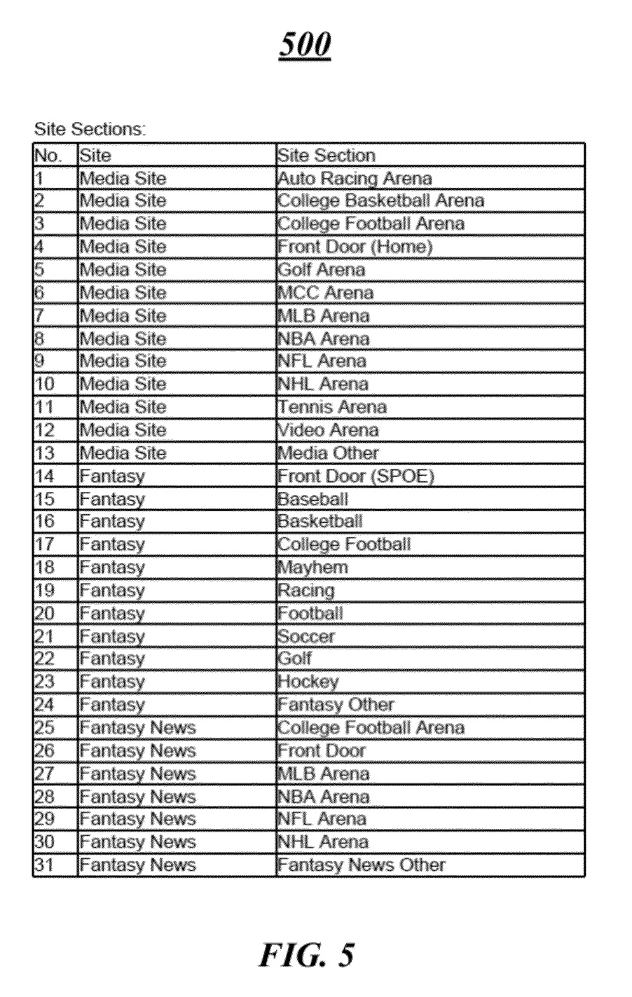

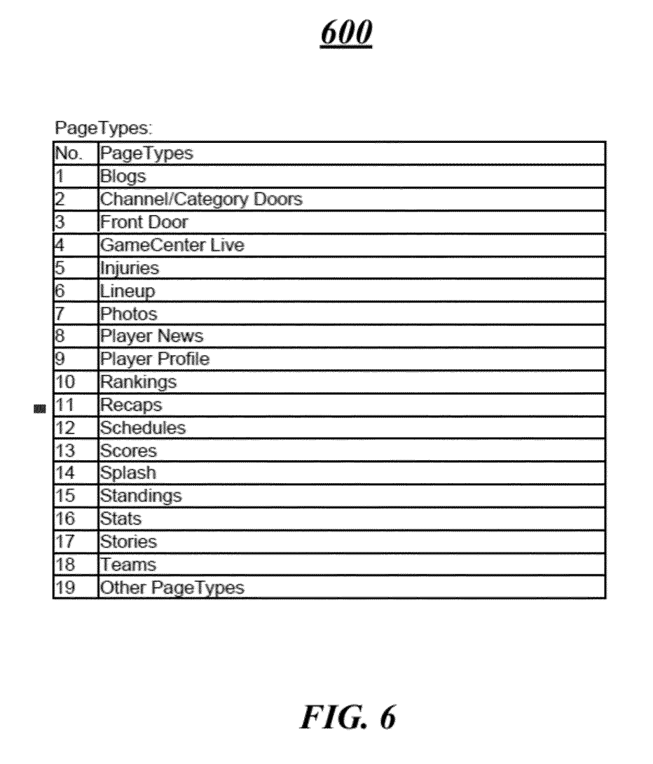

In various embodiments, traditional web metrics can also be used to understand the audience size, frequency of visit and engagement within site sections and page types. For example, product portfolio metrics may include, but are not limited to, unique users, sessions, TOS (time-spent on site in minutes), net ad revenue, net subscription revenue, sessions per user (frequency), TOS per user (engagement), and net revenue per user (monetization). FIGS. 5 and 6 illustrate tables 500 and 600 respectively that describe the site sections and page types reported for a website like CBSSports.com. In various embodiments, only the main section and page types are broken out and all others are rolled into the “other” categories to conserve space and reduce complexity. Other embodiments are described and claimed.

In some embodiments, the product portfolio described and shown in FIGS. 5 and 6 may include 1 brand total (CBSSports.com total), 3 site totals (Media Site total, Fantasy total and Fantasy News total), 31 site sections and 19 page types (54 in all). In a database layout for this example, 54 columns per metric are required each month to create the product portfolio reports. Because metrics like ‘sessions per user’ and ‘TOS per user’ are derivations of other metrics, these do not require columns in the database. Furthermore, ‘unique users’ may be represented in the rows of the database and do not require columns. The metrics that require columns in this example are: sessions (54), TOS (54), net ad revenue (54) and net subscription revenue (54). In all, the product portfolio in the above-described example website would require 216 columns in a database. The embodiments are not limited in this context.

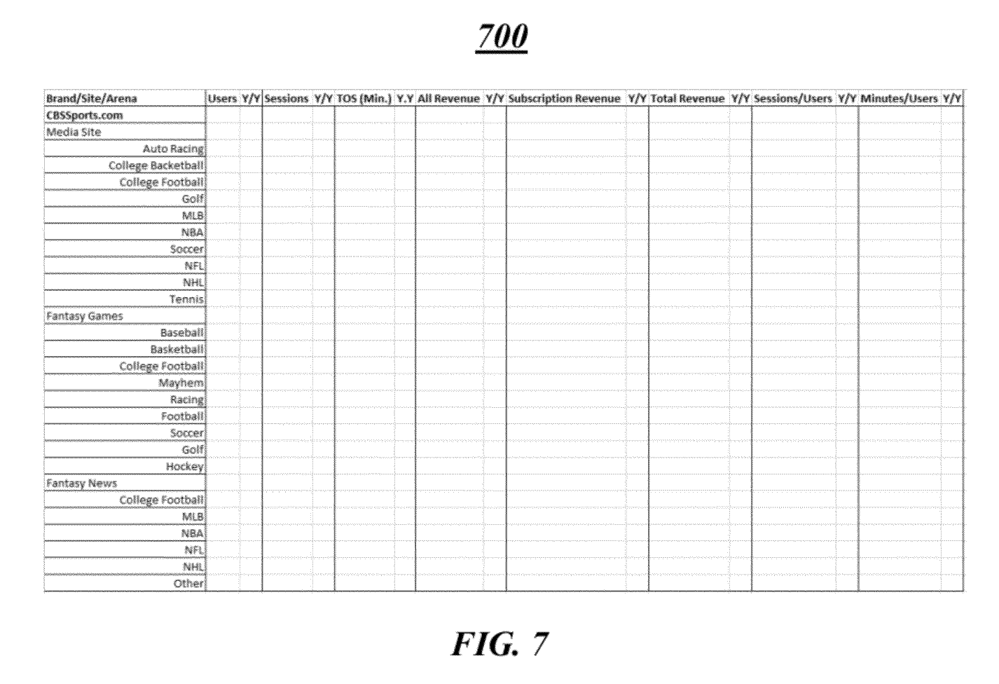

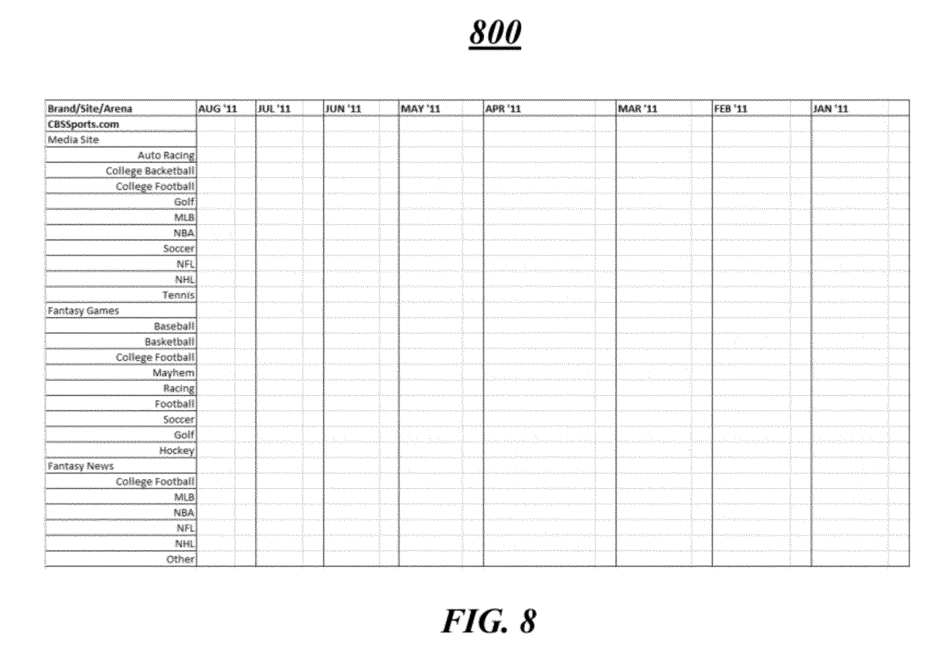

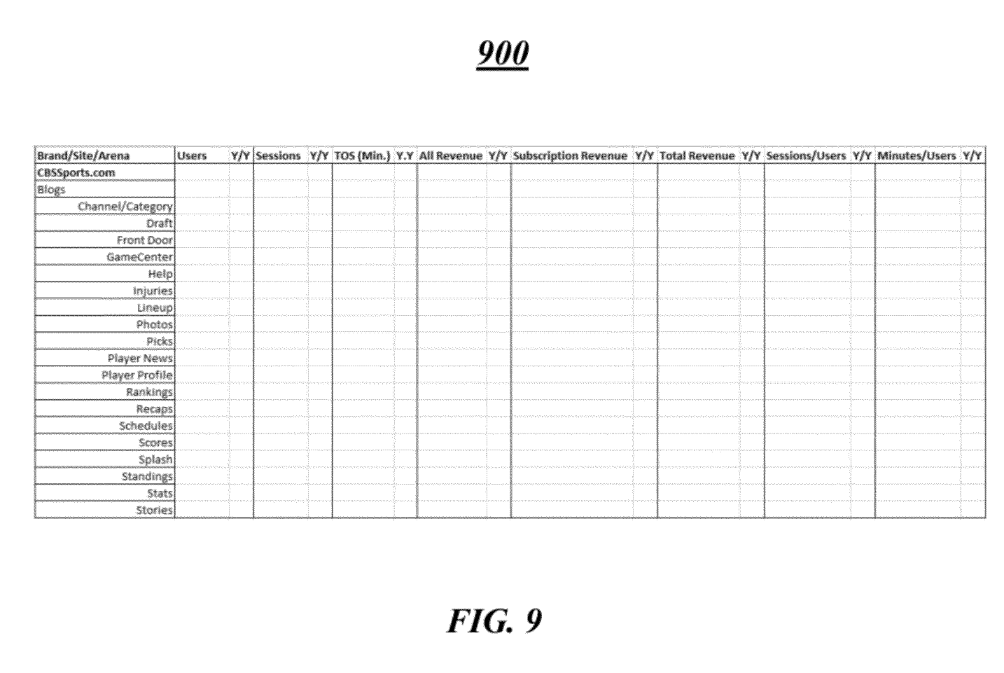

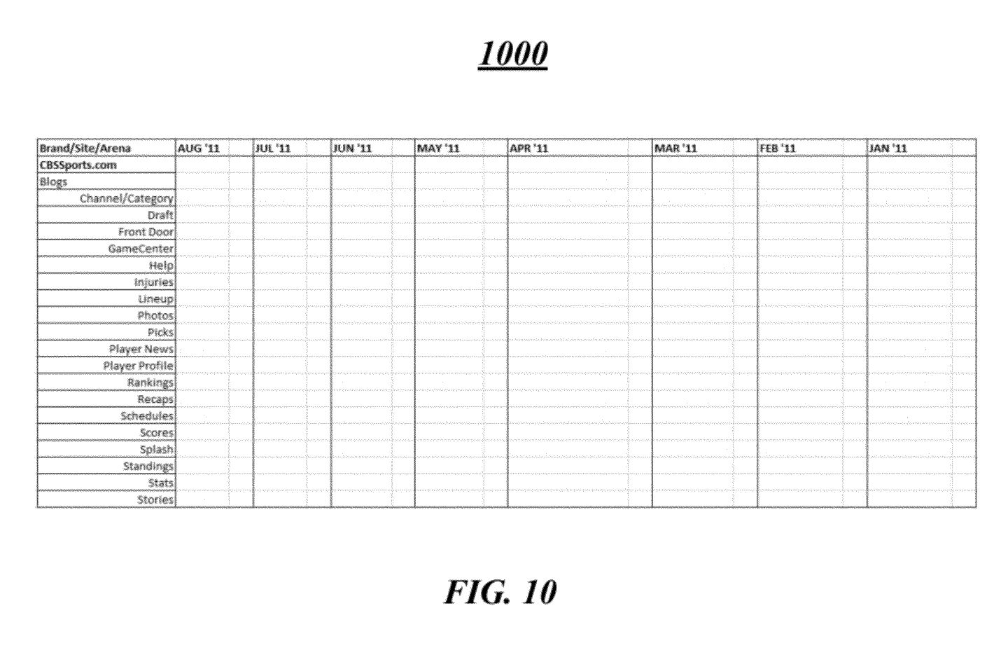

The site section, page types and user metrics described above may be used to create various reports in some embodiments. For example, the reports illustrated in FIGS. 7, 8, 9, and 10 may be generated based on the above-described content. More particularly, report 700 of FIG. 7 may comprise a product portfolio report that includes a break down of the various site sections. Report 800 of FIG. 8 may include a product portfolio report that includes a site sections trend report. In some embodiments, report 900 of FIG. 9 may include a product portfolio report including a page type report and report 1000 of FIG. 10 may include a product portfolio report including a page type trend report. In various embodiments, each of these reports may include different data that provides insight into the value generated by users and by various content, classes, portfolios, page types and products of one or more websites. While a limited number, type and arrangement of reports are shown in FIGS. 7-10, one skilled in the art would understand that any number, type or arrangement of data could be included in reports 700-1000 and still fall within the described embodiments.

In various embodiments, another important aspect of tracking and recording user metrics for a website may include accurate user identification and storing of key information from all users that visit a particular website or family of sites. In some embodiments, user metric module 208 may be operative to identify a user and determine if the user is a registered user or an anonymous user. For example, when a user visits a website, a cookie or other user identifier may be used to identify the web browser and by proxy the user. In various embodiments, the cookie may be called anon_cookie and is unique to the browser used. If the same user visits the website with a different browser or from another location or device, he or she may get another anon_cookie and the website may not know that the separate anon-cookie identifiers refer to the same user. This is a limitation of census or count based analytics systems and these systems typically build in an understanding that a certain level of duplication exists in the metric “unique user.” Testing of nearly 2 million users per month that identify themselves on a website (e.g. are registered (reg_ID) and logged in) has found the following: 48% of all reg_IDs had one anon_cookie associated with it, 21% of all reg_IDs had two anon_cookie associated with it, 10% of all reg_IDs had three anon_cookie associated with it, 6% of all reg_IDs had four anon_cookie associated with it, and 15% of all reg_IDs had five or more anon_cookie associated with it. This analysis also found nearly all anon_cookies had just one reg_ID associated with it (95%). This scenario plays out on public/shared terminals where one browser (anon_cookie) may have two or more users (reg_IDs) that accessed the website.

A user can visit a website in one of two states: 1) Anonymous or 2) Identified/Registered (e.g. logged-in). In some embodiments, a user can also change states during a session. By registering for a website ID or logging-in (if they previously created an ID), a user can go from an anonymous state to an identified state. A user can also go from an identified state to an anonymous state by clicking a “log out” button. In various embodiments, user metric module 206 may be operative to capture and store data for both Anonymous and Identified/registered users.

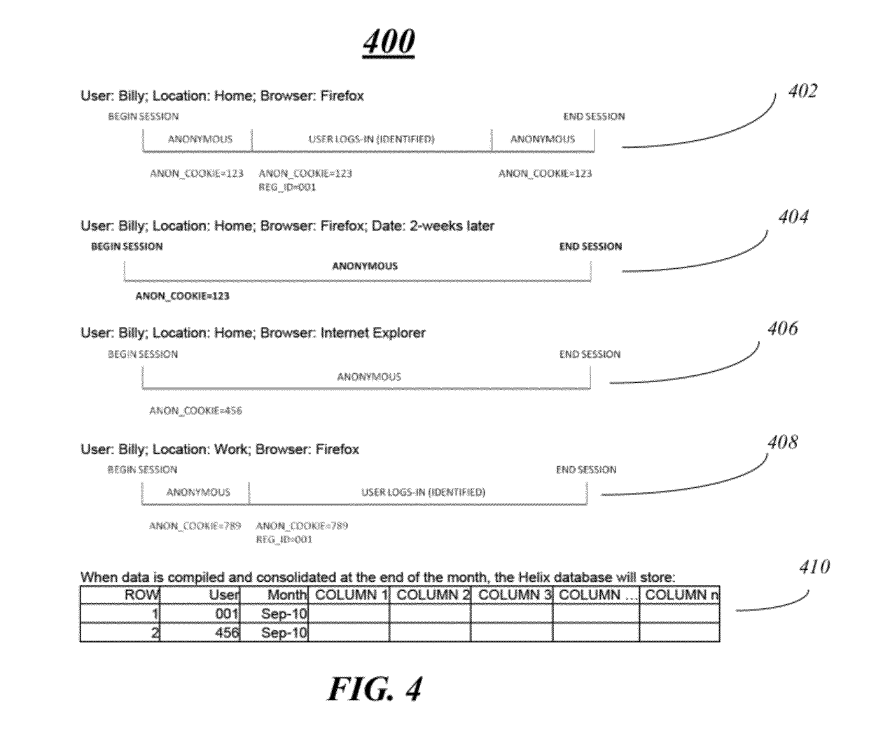

As shown in report 400 of FIG. 4, user metric module 208 may be operative to consolidate one or more activities stored in the database for a registered user having a plurality of user identifiers, wherein the plurality of user identifiers comprise one or more of cookies, addresses, browser types, computing devices or locations used to access the website. Using the example statistics above, the consumption data of the 52% of identified users with two or more anon_cookies may be consolidated into one row per user. The example illustrated in FIG. 4 shows a sample consolidation process. In the table 410 of FIG. 4, ROW 1 contains data from anon_cookie 123 (first session 402 & second session 404) and ROW 2 contains data from anon_cookie 456 (user never identified himself so no consolidation is possible, 404, 406).

In various embodiments, benefits of storing data in this consolidated manner may include, but are not limited to, reducing the volume of data as one or more anon_cookies are consolidated into one reg_id (thereby reducing the number of rows) and anon_user consumption may be bridged or correlated with their identified consumption making it possible to attribute success events like registration to specific marketing campaigns and offers in various embodiments. In some embodiments, where two or more reg_IDs are associated with one anon_cookie, consumption data may be divided at the session level (sessions prior the log-in of the second reg_ID go to the first reg_ID). In cases where two or more reg_IDs are associated with one anon_cookie and they share the same session, all consumption data may be given to the first reg_ID. As the previously presented sample analysis showed, the vast majority of all anon_cookies have just one reg_ID (95%) so the impact of erroneously attributing data with these arbitrary rules is minimal. Correctly attributing and correlating data, actions, value and other parameters to specific users may allow for more accurate value tracking by the systems described herein. Other embodiments are described and claimed.

In some embodiments, user metric module 208 may be operative to group users in the database 260 based on user attributes and calculate user metrics for the groups. For example, the user attributes may comprise one or more of age, sex, predefined preferences, browsing history or activity history for a user. In various embodiments, user portfolios may be used to depict the value of users. In some embodiments, user metric module 208 may be operative to store the value of each user in database 260, which may allow for the easy presentation of information in terms of groups of like-users. For example, users with similar attributes and activities each month may be segmented into “classes” and the value of each class may be reported in a user portfolio report as well as in a migration of users from one class to the next each month.

In various embodiments, user portfolios for a particular site may be divided into classes. In the example of CBSSports.com, users may be divided into ten classes corresponding to “sports users” and “fantasy users.” Under each of sports users and fantasy users, users may be assigned a participation value for each of a plurality of activity classes. For example, participation values may include, but are not limited to, no participation, passive, engaged, social and advocate. In some embodiments, each user in the database 260 may categorized into both a sports user class and a fantasy user class, but users can only belong to one activity class in each. For example, a user that only reads stories on media site may be classified as a “passive sports user” and a “no participation fantasy user.” A user that posts on a non-fantasy message board and reads stories on a fantasy news site may be classified as a “social sports user” and a “passive fantasy user.” Other embodiments are described and claimed.

In some embodiments, the migration of users from class to class each month is another key insight that may be tracked and recorded by user metric module 208. For example, users in a fantasy users class 0 (e.g. no fantasy participation) generated no value for CBSSports.com because they did not visit any fantasy sports related websites. It may be valuable to understand how many users from a prior month fell to class 0 in a current month and how much revenue was lost as a result. Equally important may be how many users from a prior month migrated to higher value classes (e.g. engaged, social or advocate classes) and how much additional revenue the migrations generated. In some embodiments, a class migration report may be generated by user metric module 208.

A master user table may be generated by the user metric module 208 in some embodiments. For example, a master user table may be operative or arranged to store consolidated user key data for long periods of time (years) in order to execute ad hoc analyses and lifetime-value analyses. By generating a master user table, a seasonal business such as a business that focuses on sports and sports seasons may be able to generate and analyze year over year comparisons and understanding of user consumption of content, products, services and offers over many years. Other embodiments are described and claimed.

In various embodiments, user metric module 208 may be operative to track and report information relating to campaign value or campaign attribution. For example, campaign attribution may represent: 1) the performance of campaigns and success events and 2) the value over time (e.g. lifetime value) of users initially referred by campaigns or that completed certain “success events” on a website.

Every page viewed on a website is the result of either an organic referral or a campaign referral. For example, a user may search for Randy Moss using a search engine and may find a non-paid search result link to a website. This may comprise an organic referral (e.g. the website had nothing directly to do with the referral). On the other hand, a user may search for Randy Moss using a search engine and may find and click on a paid result link that directs them to a website. This may comprise an example of a campaign-driven referral.

In some embodiments, each campaign may have a campaign identifier associated with them that is included in the link that directs the users to the target site. By counting all instances of campaign identifiers tracked by user metric module 208 in the database 260, it may be possible to determine how many users a particular campaign drove (new and returning) and how many minutes the users spent on the site during the session. The same may apply to onsite click-throughs as well, where a user may arrive on a target site by clicking on an internal campaign link.

In various embodiments, user metric module 208 may be operative to track campaign attribution information in database 280. For example, a table may be generated in database 280 that stores parsed campaign identifier information and associates it with particular users. In one example, the fields of the table may include but are not limited to, event_dt_ht, anon_cookie, reg_id, P_GUID, is_new_user, campaign identifier, product, product year, medium, target audience, source site, location, unit, creative version and success_event. In some embodiments, this table may be used to create reports whose data can be cut in a number of ways. For example, a marketer may want to see data for all 2010 products or for only campaigns that ran on television. The data from the table may be used to generate a campaign performance report.

A new user that arrived via a campaign identifier and registered with a website may be tied to an “initial referrer” tag in some embodiments. This user can then be tracked over time, thereby attributing his or her lifetime value to the campaign that referred him initially to the website. In addition to understanding the value of campaigns that drive users to a website, it may also be helpful to understand the value of certain predefined success events, such as signups to fantasy products and games, general registration on the site and community registration. The embodiments are not limited in this context.

User metric module 208 may additionally be operative to automatically select and display content, products, services or campaigns on a website based on user attributes if the user comprises a registered user in some embodiments. For example, a website may be customized or arranged to include specific content or other martial particularly suited to the needs or wants of a registered user. In some embodiments, a registered user may select certain preferences at the time of registration (or thereafter), and these preferences, along with information collected by user metric module 208, may be used to select customized material for the website that is viewable by the registered user. Other embodiments are described and claimed.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer or computer processor).

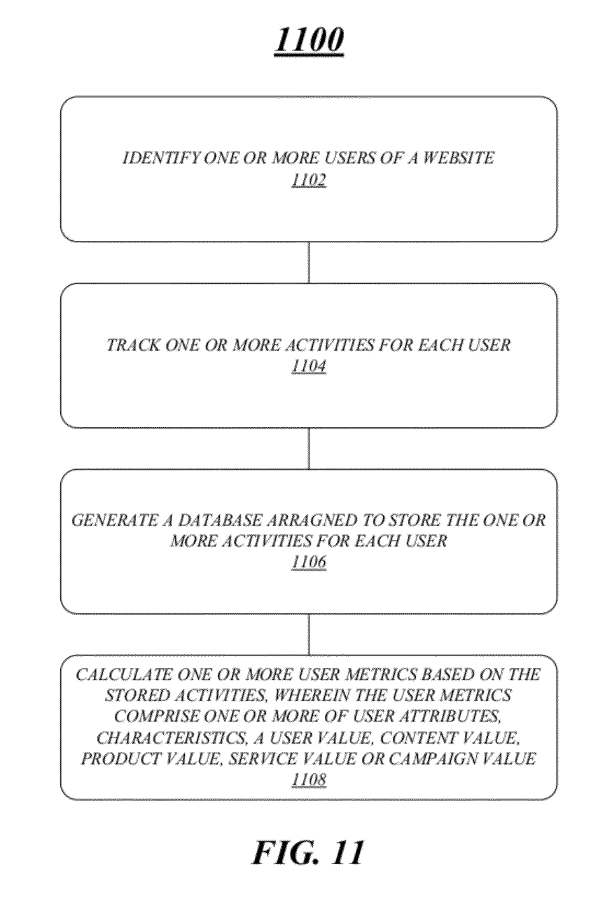

FIG. 11 illustrates one embodiment of a logic flow 1100. The logic flow 1100 may be representative of some or all of the operations executed by one or more embodiments described herein. In the illustrated embodiment shown in FIG. 11, the logic flow 1100 includes identifying one or more users of a website at 1102. For example, user metric module 120 may be operative to identify a user of client system 110 when the user accesses a website hosted by web server 140-1. The logic flow 1100 may include tracking one or more activities for each user at 1104. For example, user metric module 120 may be operative to track the activities of the user of client system 110 as they interact with a website.

In various embodiments, the logic flow 1100 may include generating a database arranged to store the one or more activities for each user at 1106. For example, user metric module 120 may be operative to generate or populate database 160 with information about the activities performed by the user of client device 110. In some embodiments, the logic flow 1100 may include calculating one or more user metrics based on the stored activities at 1108, wherein the user metrics comprise one or more of a user value, content value, product value, service value or campaign value. For example, the user metric module 120 may be operative to calculate a value associated with a user, product, content, website, advertisement, campaign or other feature of a web based property based on the information in database 160. Other embodiments are described and claimed.

In some embodiments, the logic flow may include calculating a user value based on a sum of revenues generated by a user during one or more visits to the website, calculating a content value based on a sum revenues generated by each user for content on the website, calculating a product value based on a sum of revenues generated by each user for one or more products on the website, calculating a service value based on a sum of revenues generated by each user for one or more services on the website, or calculating a campaign value based on a sum of revenues generated by users taking a desired action associated with one or more campaigns. Each of the foregoing calculations may be performed by user metric module 120 and may comprise information used by a website owner or administrator to better understand where value is derived from in view of activities of users on one or more websites.

The logic flow may include generating a visual report based on the stored activities or the calculated user metrics in some embodiments. For example, any number of visual reports, such as the reports shown in FIGS. 3A-10, may be generated by user metric module 120. Each of the reports may be generated into a human readable format that is displayed on a digital display or reproduced in a readable format for human consumption. The embodiments are not limited in this context.

In various embodiments, the logic flow may include identifying a user and determining if the user is a registered user or an anonymous user. For example, user metric module 120 may be operative to identify a user of client system 110 based on certain identifiers associated with client device 110 and may also or alternatively determine if a user is a registered user based on the entry or non-entry of registration or identification credentials by the user. In various embodiments, content, products, services or campaigns may be automatically selected and displayed on the website based on user attributes if the user comprises a registered user. In some embodiments, for example, the user attributes may comprise one or more of age, sex, predefined preferences, browsing history or activity history for a user.

One or more activities stored in the database for a registered user having a plurality of user identifiers may be consolidated in some embodiments of the logic flow 1100. For example, a plurality of user identifiers associated with a single user may result from a user accessing a website from a plurality of locations, which may result in different user identifiers such as one or more of cookies, addresses, browser types, computing devices or locations used to access the website being recorded. In various embodiments, users may be grouped in the database based on user attributes and a participation value may be assigned to each user for each of a plurality of activity classes. In some embodiments the participation value comprises one or more of no participation, passive, engaged, social, or advocate. For example, user metric module 120 may group users in database 160 based on how they generate value, user profile information, statistics, user activity information or any other suitable parameter. Other embodiments are described and claimed.

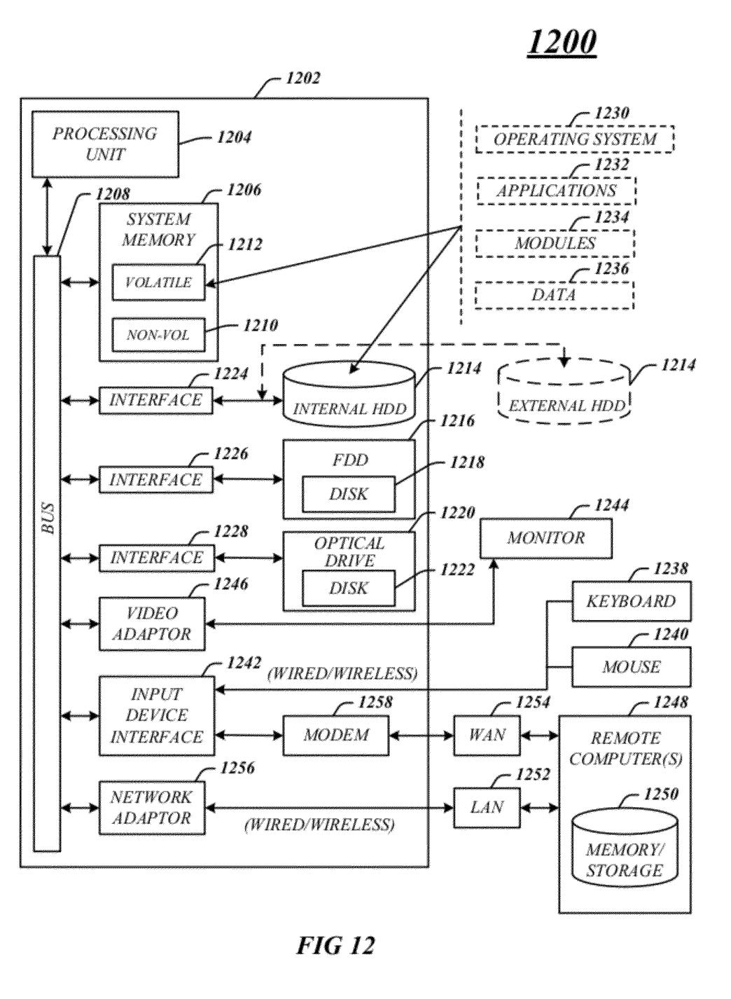

FIG. 12 illustrates an embodiment of an exemplary computing architecture 1200 suitable for implementing various embodiments as previously described. The computing architecture 1200 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 1200.

As shown in FIG. 12, the computing architecture 1200 comprises a processing unit 1204, a system memory 1206 and a system bus 1208. The processing unit 1204 can be any of various commercially available processors. Dual microprocessors and other multi-processor architectures may also be employed as the processing unit 1204. The system bus 1208 provides an interface for system components including, but not limited to, the system memory 1206 to the processing unit 1204. The system bus 1208 can be any of several types of bus structure that may further interconnect to a memory bus (with or without a memory controller), a peripheral bus, and a local bus using any of a variety of commercially available bus architectures.

The system memory 1206 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 12, the system memory 1206 can include non-volatile memory 1210 and/or volatile memory 1212. A basic input/output system (BIOS) can be stored in the non-volatile memory 1210.

The computer 1202 may include various types of computer-readable storage media, including an internal hard disk drive (HDD) 1214, a magnetic floppy disk drive (FDD) 1216 to read from or write to a removable magnetic disk 1218, and an optical disk drive 1220 to read from or write to a removable optical disk 1222 (e.g., a CD-ROM or DVD). The HDD 1214, FDD 1216 and optical disk drive 1220 can be connected to the system bus 1208 by a HDD interface 1224, an FDD interface 1226 and an optical drive interface 1228, respectively. The HDD interface 1224 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1210, 1212, including an operating system 1230, one or more application programs 1232, other program modules 1234, and program data 1236. The one or more application programs 1232, other program modules 1234, and program data 1236 can include, for example, the trending component 120 of FIG. 1.

A user can enter commands and information into the computer 1202 through one or more wire/wireless input devices, for example, a keyboard 1238 and a pointing device, such as a mouse 1240. Other input devices may include a microphone, an infra-red (IR) remote control, a joystick, a game pad, a stylus pen, touch screen, or the like. These and other input devices are often connected to the processing unit 1204 through an input device interface 1242 that is coupled to the system bus 1208, but can be connected by other interfaces such as a parallel port, IEEE 1394 serial port, a game port, a USB port, an IR interface, and so forth.

A monitor 1244 or other type of display device is also connected to the system bus 1208 via an interface, such as a video adaptor 1246. In addition to the monitor 1244, a computer typically includes other peripheral output devices, such as speakers, printers, and so forth.

The computer 1202 may operate in a networked environment using logical connections via wire and/or wireless communications to one or more remote computers, such as a remote computer 1248. The remote computer 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the LAN 1252 through a wire and/or wireless communication network interface or adaptor 1256. The adaptor 1256 can facilitate wire and/or wireless communications to the LAN 1252, which may also include a wireless access point disposed thereon for communicating with the wireless functionality of the adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wire and/or wireless device, connects to the system bus 1208 via the input device interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

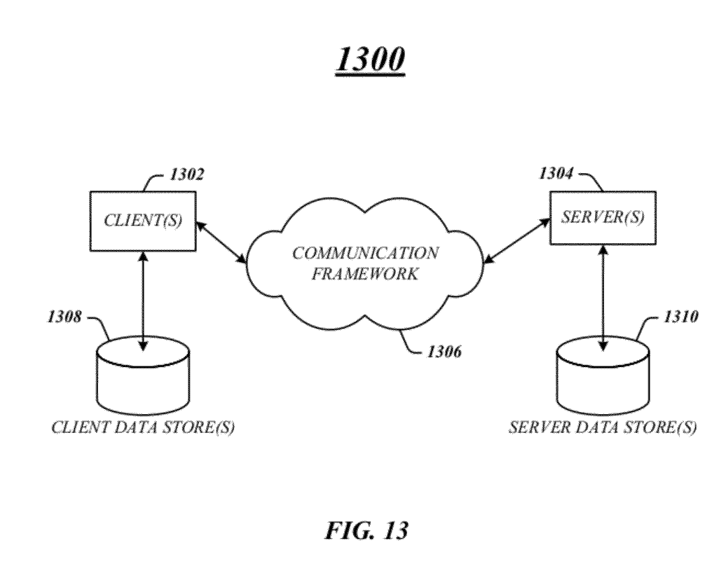

FIG. 13 illustrates a block diagram of an exemplary communications architecture 1300 suitable for implementing various embodiments as previously described. The communications architecture 1300 includes various common communications elements, such as a transmitter, receiver, transceiver, radio, network interface, baseband processor, antenna, amplifiers, filters, and so forth. The embodiments, however, are not limited to implementation by the communications architecture 1300.

As shown in FIG. 13, the communications architecture 1300 comprises one or more clients 1302 and servers 1304. The clients 1302 may implement the client systems 110. The servers 1304 may implement the server system 330 and 340-1-n. The clients 1302 and the servers 1304 are operatively connected to one or more respective client data stores 1308 and server data stores 1310 that can be employed to store information local to the respective clients 1302 and servers 1304, such as cookies and/or associated contextual information.

The clients 1302 and the servers 1304 may communicate information between each other using a communication framework 1306. The communications framework 1306 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 1302 and the servers 1304 may include various types of standard communication elements designed to be interoperable with the communications framework 1306, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 1302 and a server 1304 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. In various embodiments, the storage medium may include a non-transitory storage medium. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
identifying one or more users of a website;
tracking one or more activities for each user;
generating a database arranged to store the one or more activities for each user; and
calculating one or more user metrics based on the stored activities, wherein the user metrics comprise one or more of a consolidation of multiple user visits, user value, content value, product value, service value or campaign value.

2. The computer-implemented method of claim 1, comprising:
calculating a user value based on a sum of revenues generated by a user during one or more visits to the website.

3. The computer-implemented method of claim 1, comprising:
calculating a content value based on a sum revenues generated by each user for content on the website;
calculating a product value based on a sum of revenues generated by each user for one or more products on the website; or
calculating a service value based on a sum of revenues generated by each user for one or more services on the website.

4. The computer-implemented method of claim 1, comprising:
calculating a campaign value based on a sum of revenues generated by users taking a desired action associated with one or more campaigns.

5. The computer-implemented method of claim 1, comprising:
generating a visual report based on the stored activities or the calculated user metrics.

6. The computer-implemented method of claim 1, comprising:
identifying a user;
determining if the user is a registered user or an anonymous user; and
automatically selecting and displaying content, products, services or campaigns on the website based on user attributes if the user comprises a registered user.

7. The computer-implemented method of claim 6, wherein user attributes comprise one or more of age, sex, predefined preferences, browsing history or activity history for a user.

8. The computer-implemented method of claim 6, comprising:
consolidating one or more activities stored in the database for a registered user having a plurality of user identifiers, wherein the plurality of user identifiers comprise one or more of cookies, addresses, browser types, computing devices or locations used to access the website.

9. The computer-implemented method of claim 1, comprising:
grouping users in the database based on user attributes; and
assigning a participation value to each user for each of a plurality of activity classes.

10. The computer-implemented method of claim 9, wherein the participation value comprises one or more of no participation, passive, engaged, social, or advocate.

11. An article comprising a computer-readable storage medium containing instructions that if executed by a processor enable a system to:
identify one or more users of a website;
track one or more activities for each user;
generate a database arranged to store the one or more activities for each user; and
calculate one or more user metrics based on the stored activities, wherein the user metrics comprise one or more of a consolidation of multiple user visits, user value, content value, product value, service value or campaign value.

12. The article of claim 11, comprising instructions that if executed enable the system to:
calculate a user value comprising a sum of revenues generated by a user during one or more visits to the website;
calculate a content value comprising a sum of revenues generated by each user for content on the website;
calculate a product value comprising a sum of revenues generated by each user for one or more products on the website;
calculate a service value comprising a sum of revenues generated by each user for one or more services on the website; or calculate a campaign value comprising a sum revenues generated by users taking a desired action associated with one or more campaigns.

13. The article of claim 11, comprising instructions that if executed enable the system to:
generate a visual report based on the stored activities or the calculated user metrics.

14. The article of claim 11, comprising instructions that if executed enable the system to:
identify a user;
determine if the user is a registered user or an anonymous user; and
automatically select and display content, products, services or campaigns on the website based on user attributes if the user comprises a registered user.

15. The article of claim 14, wherein user attributes comprise one or more of age, sex, predefined preferences, browsing history or activity history for a user.

16. The article of claim 14, comprising instructions that if executed enable the system to:
consolidate one or more activities stored in the database for a registered user having a plurality of user identifiers, wherein the plurality of user identifiers comprise one or more of cookies, addresses, browser types, computing devices or locations used to access the website.

17. The article of claim 11, comprising instructions that if executed enable the system to:
group users in the database based on user attributes; and
assign a participation value to each user for each of a plurality of activity classes, wherein the participation value comprises one or more of no participation, passive, engaged, social, or advocate.

18. An apparatus, comprising:
one or more processors; and
a memory communicatively coupled to the one or more processors, the memory operative to store a user metric module that when executed by the one or more processors is operative to generate a database arranged to store one or more activities tracked for each of a plurality of users of one or more websites and calculate one or more user metrics based on the stored activities, wherein the user metrics comprise one or more of a consolidation of multiple user visits, user value, content value, product value, service value or campaign value.

19. The apparatus of claim 18, the user metric module operative to:
calculate a user value comprising a sum of revenues generated by a user during one or more visits to the website;
calculate a content value comprising a sum revenues generated by each user for content on the website;
calculate a product value comprising a sum of revenues generated by each user for one or more products on the website;
calculate a service value comprising a sum of revenues generated by each user for one or more services on the website; or calculate a campaign value comprising a sum revenues generated by users taking a desired action associated with one or more campaigns; and
generate a visual report based on the stored activities or the calculated user metrics.

20. The apparatus of claim 18, the user metric module operative to:
identify a user;
determine if the user is a registered user or an anonymous user;
consolidate one or more activities stored in the database for a registered user having a plurality of user identifiers, wherein the plurality of user identifiers comprise one or more of cookies, addresses, browser types, computing devices or locations used to access the website;
group users in the database based on user attributes; and
assign a participation value to each user for each of a plurality of activity classes, wherein the participation value comprises one or more of no participation, passive, engaged, social, or advocate.
